(19) United States
(12) Patent Application Publication
(10) Pub. No.: US 2003/0114106 A1
(43) Pub. Date: Jun. 19, 2003

(54) Mobile internet solution using java application combined with local wireless interface

(76) Inventors: Kazuhiro Miyatsu, Tokyo (JP); Kyoko Kawamura, Tokyo (JP); Michael Bjorn, Tokyo (JP)

Correspondence Address: JENKENS & GILCHRIST, 3200 Fountain Place, 1445 Ross Avenue, Dallas, TX, 75202-2799, US

(21) Appl. No.: 10/024,323

(22) Filed: Dec. 14, 2001

(51) Int. Cl. H04B 5/00

(52) U.S. Cl. 455/41; 455/412; 455/410; 455/411; 380/247

(57) ABSTRACT

A telecommunications system and method for downloading application software to a local communications network via an external communications network. The local communications network comprises a plurality of devices including an interface device. The interface device includes an interface for interfacing with the external communications network for downloading an application software from an application software source to the interface device via the external communications network. The local communications network preferably comprises a local wireless network, such as a Bluetooth wireless network, and the external communications network preferably comprises a mobile communications network for downloading application software to a mobile phone of the local wireless network.

### BACKGROUND OF THE INVENTION

1. Field of the Invention

The present invention relates generally to the field of wireless telecommunications; and, more particularly, but not by way of limitation, to a communications system and method for selectively downloading application software to a local wireless communications network via a mobile telephone communications network.

2. Description of the Prior Art

A local wireless communications network is a small network of electronic devise connected to one another using a short range wireless technology such as, for example, radio or infrared. A local wireless communications network is sometimes referred to as a wireless ad hoc network because it is typically established for a relatively short time period and does not require any fixed infrastructure or administration. In effect, a local wireless communications network enables one wireless link to replace many cables or other physical connections that would otherwise be necessary to connect a plurality of electronic devices to one another.

An important example of a local wireless communications network is a Bluetooth wireless network. Bluetooth is a wireless communications technology for data and voice, and is based on a low-cost short range radio link that operates in the unlicensed radio band at 2.4 Ghz.

FIG. 1 schematically illustrates a Bluetooth wireless network to assist in explaining the present invention. The network is generally designated by reference number 10, and comprises one master device 12a and up to seven slave devices 12b-12h that are affiliated with one another to form what is referred to as a “piconet”. A piconet is, in effect, a wireless network in which all of the devices in the network are able to communicate with one another.

The plurality of devices in a piconet comprise a plurality of electronic devices having the capability of communicating in a wireless manner. As shown in FIG. 1, such electronic devices may include one or more laptop computers, mouses, printers, headsets, LAN access points, televisions, radios and the like (in this regard, it is anticipated that in the future many home appliances and other types of electronic devices will be provided with a wireless communications capability such that they may also be included in a piconet). In a Bluetooth system, traffic within a piconet is controlled by the master device. The master device uses its clock and hopping sequence to synchronize the slave devices. The Bluetooth system is a slotted access mechanism that divides each second into 1600 time slots. The time slots are either downlink slots or uplink slots. The master device uses the downlink slots to transmit to a slave device, and the slave devices use the uplink slots to transmit to the master device.

In addition to being able to communicate with one another, the plurality of electronic devices in a Bluetooth wireless network are also capable of communicating with entities that are outside of the network. In particular, as shown in FIG. 1, electronic device 12b in the piconet comprises a telephone, such as a mobile telephone, having an interface that enables communication with external entities via an external communications network such as a mobile communications network 14. Through connection to the external communications network, it is possible for any of the electronic devices in the piconet to communicate with an external entity, for example, for laptop computer 12a to gain access to the Internet.

In a local wireless communications network, such as a Bluetooth wireless network, certain functional relationships may be established between the telephone in the network and one or more of the other electronic devices in the network. For example, in the Bluetooth network shown in FIG. 1, the mobile phone 12b and the television 12d can be set up so that the telephone functions as a remote controller for the television. In order to achieve such a functional relationship in a Bluetooth network, as well as in other local wireless communications networks, appropriate application software must be loaded into the telephone (sometimes referred to herein as the “Bluetooth phone” and the television (sometimes referred to herein as a Bluetooth application end-device).

In current Bluetooth systems, all application software for the Bluetooth phone must be preloaded into the phone; and enabling of the software must be accomplished manually by an end-user. Because any new application software must be preloaded into the phone, current Bluetooth phone applications are, in effect, independent of an external communications network, e.g., a mobile communications network. This situation greatly limits the widespread use of Bluetooth phone applications; and, in addition, severely restricts the flexibility of the Bluetooth network to modify existing applications or to add new applications.

There is, accordingly, a need for a telecommunications system and method by which application software can be downloaded to a local wireless communications network, such as a Bluetooth wireless network, via an external communications network, such as a mobile communications network.

### SUMMARY OF THE INVENTION

The present invention relates to telecommunications systems and methods for downloading application software to a local communications network via an external communications network.

More particularly, one aspect of the present invention includes a telecommunications system comprising a local communications network and an external communications network. The local communications network comprises a plurality of devices including an interface device. The interface device includes an interface for interfacing with the external communications network for downloading an application software from an application software source to the interface device via the external communications network.

According to the present invention, application software can be downloaded to the interface device of a local communications network via an external communications network rather than having to be preloaded locally into the interface device. As a result, the loading of new application software becomes easier and more convenient, and the flexibility of the local communications network is increased.

According to a presently preferred embodiment of the invention, the local communications network comprises a local wireless communications network, such as a Bluetooth wireless network, the interface device comprises a mobile phone, and the external communications network comprises a mobile communications network. Preferably also, the system is designed to permit application software to be loaded into the mobile phone only via the mobile communications network, and not locally at the phone. The system of the present invention, accordingly, provides an operator of the mobile communications network with control over the use of the application software by the user of the wireless communications network; and this control can be used by the mobile network operator to create an additional source of revenue.

According to a further embodiment of the invention, the plurality of devices of the local communications network includes an application end-device, and the application software establishes a functional relationship between the interface device and the application end-device. The interface preferably comprises a JAVA Application Programming Interface (JAVA API) that is capable of enabling the application software toward the application end-device.

According to another embodiment of the present invention, a security management system is provided that will only permit application software that is downloaded from an “approved” access server to be used. The security management system, thus, will prevent unauthorized third parties from downloading application software to the interface device. According to a presently preferred embodiment of the invention, the security management system utilizes “Public Key Encryption Technology” to verify that a downloaded application software is actually one that has been generated from an approved application software provider; and, in addition, to ensure that an application end-device has been approved for connection with the interface device. Preferably, the approving authority, i.e., the Certification Authority (CA), is the mobile communications system operator so that the operator can have complete control over the downloading of the application software,

According to another embodiment of the invention, a method for operating a telecommunications system is provided in which the operator of an external communications network controls the downloading of an application software to an interface device of a local communications network. The external communications network operator receives a fee for the downloading service, for example, from a service provider that provides the application software to the external communications network. The service provider, in turn, may receive a fee from the entity that actually provides the application software.

In general, the present invention provides a system and method by which application software can be provided to an end user of a local communications network in a convenient and efficient manner. At the same time, the local communications network is integrated into existing external communications network operations in such a manner that the operator of the external communications network is provided with a new source of income.

### BRIEF DESCRIPTION OF THE DRAWINGS

Further objects, features and advantages of the present invention will become apparent hereinafter in conjunction with the following detailed description of presently preferred embodiments thereof.

FIG. 1 schematically illustrates a Bluetooth wireless communications system to assist in explaining the present invention;

FIG. 2 is a block diagram that schematically illustrates a system for downloading application software to a Bluetooth phone via a mobile communications network according to a presently preferred embodiment of the present invention;

FIG. 3 is a block diagram that schematically illustrates details of the downloading process in the system of FIG. 2 according to another embodiment of the present invention;

FIG. 4 is a block diagram that schematically illustrates details of the structure embedded in a Bluetooth phone according to a further embodiment of the present invention;

FIG. 5 is a block diagram that schematically illustrates a Bluetooth security management system according to a further embodiment of the present invention; and

FIG. 6 is a block diagram that schematically illustrates a business model for a mobile communications network according to another embodiment of the present invention.

### DETAILED DESCRIPTION OF PRESENTLY PREFERRED EMBODIMENTS OF THE INVENTION

The present invention relates to telecommunications systems and methods for downloading application software to a local communications network via an external communications network.

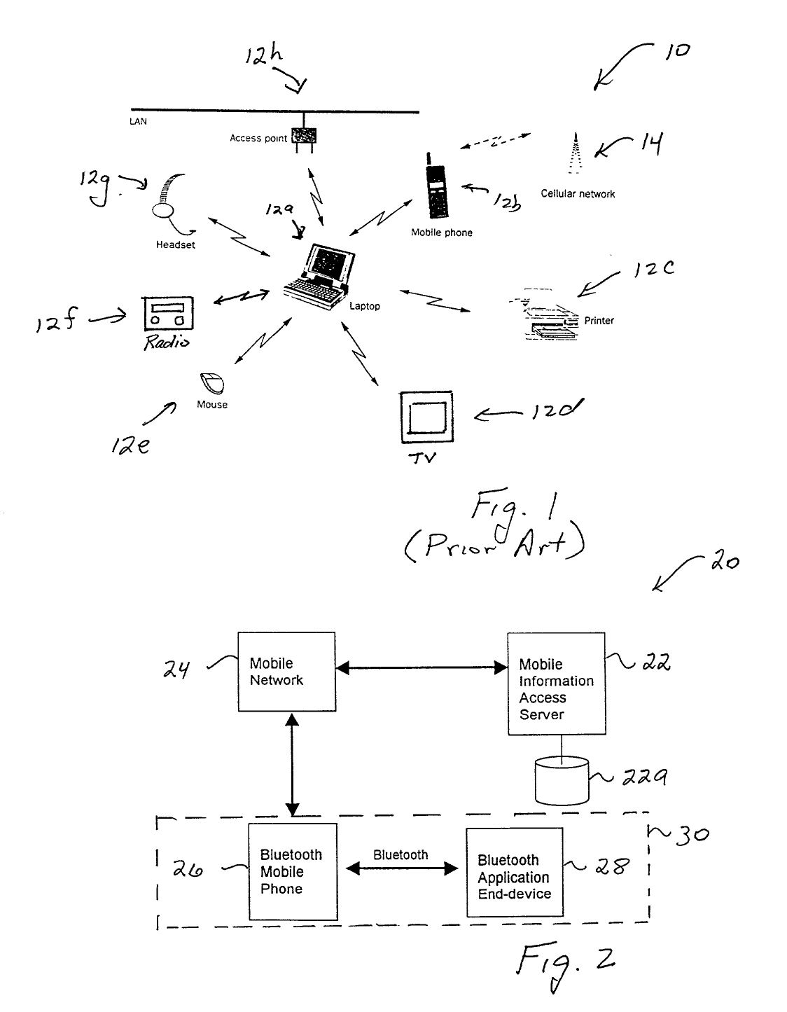

Referring now to FIG. 2, there is shown a block diagram that schematically illustrates a system for downloading application software to a Bluetooth mobile phone in a Bluetooth wireless network via a mobile communications network according to a presently preferred embodiment of the present invention. The system is generally designated by reference number 20, and comprises four basic entities including an application software source in the form of a mobile information access server 22, a mobile communications network 24, an interface device in the form of a Bluetooth mobile phone 26 and a Bluetooth application end-device 28. As shown in FIG. 1, the mobile information access server includes an associated database 22a that stores various information including an application software for the Bluetooth wireless network. The application software is downloaded to the mobile phone 26 via the mobile communications network 24. The downloaded application software is enabled to communicate over the Bluetooth wireless network 30 with the Bluetooth application end-device 28 as appropriate.

Structuring the telecommunications system of the present invention in the manner illustrated in FIG. 2, provides a basis for selective Bluetooth phone application operation. In particular, and as will be described more fully hereinafter, the system enables application software to be loadable into the Bluetooth mobile phone only from the mobile information access server 22 via the mobile network 24; and can, in most situations, prevent the loading of any new application software locally at the Bluetooth mobile phone itself. The Bluetooth application end-device can be any of a variety of types of electronic devices. As indicated above, for example, it can be a television that is adapted to be remotely controlled by the Bluetooth mobile phone. It can also comprise any one of a variety of home appliances to be controlled via the Bluetooth mobile phone or a local server incorporated in the Bluetooth network

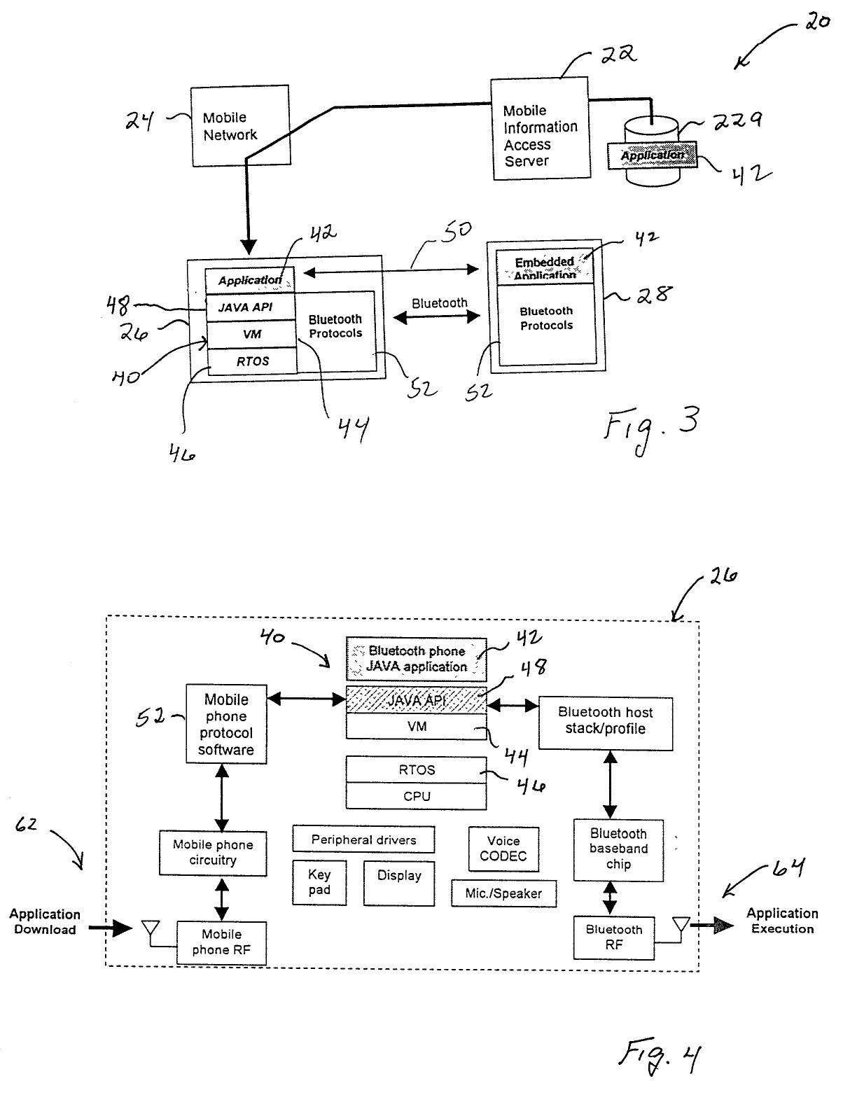

FIG. 3 is a block diagram that schematically illustrates details of the process by which telecommunications system 20 downloads application software 42 to a Bluetooth mobile phone over-the-air, i. e., via the mobile communications network 24, according to a further embodiment of the present invention. As indicated in FIG. 3, JAVA technology is preferably used for the downloading. Specifically, the application software 42 is downloaded to the Bluetooth mobile phone 26 via a JAVA interface 40 in the Bluetooth mobile phone 26. As shown in FIG. 3, the JAVA applet resides on top of a Virtual Machine (VM) 44 running on real-time operating system (RTOS) 46 through a JAVA API (JAVA Application Programming interface) 48 in the phone.

Once an application software 42 has been loaded to the Bluetooth mobile phone 26 as described above, the application software is basically operated between the Blutooth mobile phone 26 and the Bluetooth application end-device 28 as indicated by arrow 50 in FIG. 3 utilizing the appropriate protocols 52. The mobile network 24 is no longer involved in the process unless and until some future interaction with the mobile information access server is required such as when a loaded application software is to be updated or a new application software downloaded. This separation of Bluetooth mobile phone application download and execution provides a basis for the Bluetooth phone application handling according to the present invention.

The telecommunications system 20 illustrated in FIG. 3 permits an application software 42 to be efficiently downloaded to a Bluetooth mobile phone 26 over-the-air. However, it is still necessary to enable the application software to the Bluetooth application end device 28 in the Bluetooth wireless network. The current JAVA API in communication library, i.e., HTTP, cannot specify which communication bearer to use. It is often the case that HTTP assumes the communication bearer is the mobile network. According to a further embodiment of the present invention, accordingly, a new API is introduced to achieve appropriate communication interface handling, i.e., to ensure that the JAVA API will be able to selectively choose the correct Bluetooth interface port for communication with the Bluetooth application end-device via the JAVA application.

In particular, FIG. 4 is a block diagram that schematically illustrates details of the structure embedded in the Bluetooth mobile phone 26 according to a further embodiment of the present invention (only those components of the phone that are pertinent to the present invention are described herein as other illustrated components are generally conventional and will be well-understood by those skilled in the art). As illustrated in FIG. 4, the mobile phone 26 includes two available wireless interfaces, one interface 62 for application software download to the phone, and one interface 64 for application execution. When the Bluetooth JAVA application runs, it chooses Bluetooth as the communication bearer by specifying Bluetooth in the JAVA program.

An example of a JAVA script for opening the communication interface for HTTP is:

import java.io.InputStream;

import javax.microedition.io.Connector;

InputStream in;

in=Connector.openInputStream(“http://localhost/index.html”). In order to specify another communication interface, such as Bluetooth, a new interface call command is introduced such as, for example, “Bluetooth://xxxxx/yyy”. The script will then be as follows:

in=Connector.openInputStream(“Bluetooth://xxxxx/yyy”).

By defining the Bluetooth interface call functionality among JAVA API, Bluetooth phone application software downloaded through a mobile communications network can enable the interface in the Bluetooth mobile phone to run the application. It is desirable, however, that a mechanism be included to provide for security management among the three basic entities involved in the application software downloading process, i.e., the mobile information access server, the Bluetooth mobile phone and the Bluetooth application end-device. Such multiple-party security is important to exclude unapproved Bluetooth JAVA application software from being downloaded to the phone, and also for preventing Bluetooth application software execution for unapproved Bluetooth application end-devices.

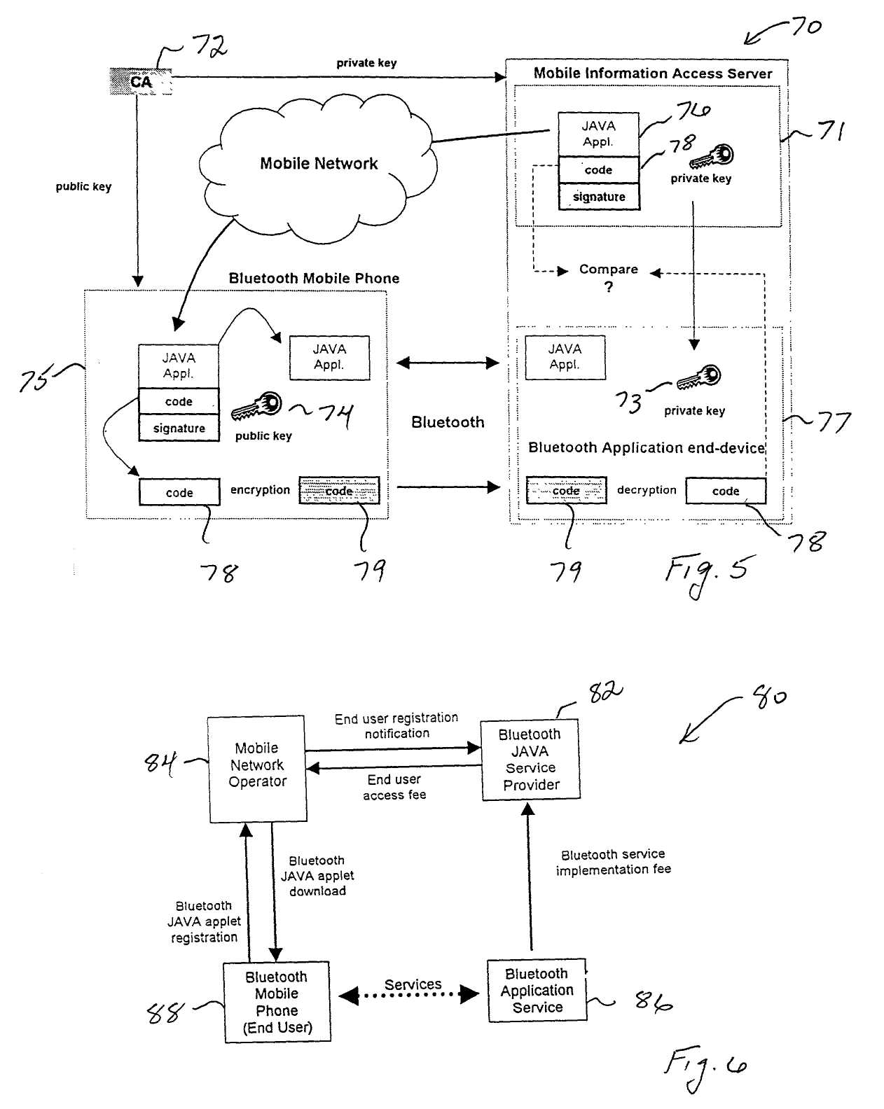

In particular, FIG. 5 is a block diagram that schematically illustrates a Bluetooth security management system 70 according to a further embodiment of the present invention. As shown in FIG. 5, in order to limit the use of JAVA application software only to application software downloaded from an approved access server 71, a “Public Key Encryption Technology” scheme is employed. The principal features of this technology include:

1. Encrypted data using a public key can only be decrypted using a private key, and

2. Decryption of encrypted data using a private key can only be achieved using a public key.

As schematically illustrated in FIG. 5, Bluetooth JAVA application providers must initially be issued their electronic identities from a Certification Authority (CA) 72 with a unique private key 73 and a public key 74. Preferably, the CA is the operator of the mobile communications network. The private key is used to append the provider's electronic signature with the JAVA Bluetooth application software. Since a public key is open and is possessed in the mobile phone 75 beforehand, it is possible to verify if the downloaded Bluetooth JAVA application software 76 is actually the one generated from the certified application provider 71, if the proper electronic signature is appended to the application software.

Once the downloaded application software has been verified, the next step in the security procedure is to verify that the Bluetooth application end-device is the correct target before the mobile phone 75 starts application service with it. In this regard, it is assumed that a secret code 78 is embedded in the application software before it is sent. The Bluetooth mobile phone 75 extracts the secret code 78 from the downloaded application software to encrypt it with the given public key 74 before sending a communication request to the Bluetooth application end-device 77. This code can be anything but a simple code as long as it is known only to the Bluetooth application end-device. The Bluetooth application end-device 77 receives the encrypted request code 79 and decrypts it using the private key 73 given to it by the CA. If the originally embedded code and this decrypted code are identified to be the same, it is assured that the Bluetooth mobile phone 75 is requesting Bluetooth connection to a qualified Bluetooth application end-device 77 based on the pre-certified Bluetooth JAVA application software.

It should be noted that in the above-described security management system, the private key is shared between the JAVA application software in the server and the Bluetooth application end-device. Although these two entities are physically separated, the owner of the two entities are often the same, or, at least, close partners. Thus, the private key can be securely shared between the two entities without any problem.

The telecommunications system of the present invention integrates a mobile communications network with a local wireless network in such a manner that the operator of the mobile communications network, as the Certification Authority, can exclusively and securely control Bluetooth application software usage. Such exclusive control permits a suitable business model to be established so as to provide a new revenue source to the mobile communications network operator. A business model 80 according to a further embodiment of the invention is schematically illustrated in FIG. 6.

As shown in FIG. 6, a Bluetooth JAVA service provider 82 pays an access fee to the operator 84 of the mobile communications network, while the operator maintains control over who downloads the Bluetooth service as described above. The service provider, in turn, receives a fee from entities 86 that actually provide the application software. As an example, the service provider may be an advertising agent that receives a fee from its clients; i.e., from entities that provide the application software. The service provider then pays a fee to the mobile network operator 84 so that the application software can be downloaded for use by the end user 88.

In general, the present invention provides mobile communications network operators with the capability of integrating their mobile communications network with a local wireless network such as a Bluetooth wireless network. This integration creates a situation in which the local wireless network is complementary to the mobile communications network rather than in conflict with it. At the same time, the mobile communications network operator can realize an added source of revenue that is not currently available.

It should be understood that the term “comprises/comprising” when used in this specification, is taken to specify the presence of stated features, integers, steps or components; but does not preclude the presence or addition of one or more other features, integers, steps, components or groups thereof.

While what has been described herein constitutes presently preferred embodiments of the invention, it should be understood that the invention can be varied in numerous ways without departing from the scope thereof. For example, although the invention has been described primarily in connection with a Bluetooth wireless network, this is intended to be exemplary only. For example, the local communications network can comprise a wireless LAN, an IrDA network or any other local wireless network. Because the invention can be varied in numerous ways, it should be recognized that the invention should be limited only insofar as is required by the scope of the following claims

We claim:

1. A telecommunications system, comprising:
a local communications network and an external communications network, said local communications network comprising a plurality of devices including an interface device, said interface device including an interface for interfacing with said external communications network for downloading an application software from an application software source to said interface device via said external communications network.

2. The telecommunications system according to claim 1, wherein said external communications network comprises a mobile communications network.

3. The telecommunications system according to claim 2, wherein said local communications network comprises a local wireless network and wherein said interface device comprises a mobile phone.

4. The telecommunications system according to claim 3, wherein said local wireless network comprises a Bluetooth wireless network.

5. The telecommunications system according to claim 1, wherein said plurality of devices further includes an application end-device, and wherein said application software establishes a functional relationship between said interface device and said application end-device.

6. The telecommunications system according to claim 5, wherein a secret request code is embedded in said application software, and wherein said interface device includes a public key for encrypting said secret request code prior to sending a communication request to said application end-device.

7. The telecommunications system according to claim 6, wherein said application end-device includes a private key for decrypting said encrypted secret request code to be identified as an approved application end-device.

8. The telecommunications system according to claim 5, wherein said interface comprises a JAVA Application Programming Interface.

9. The telecommunications system according to claim 8, wherein said JAVA Application Programming Interface comprises an Application Programming Interface for selectively identifying an interface port for enabling the application software toward the application end-device.

10. The telecommunications system according to claim 9, and further including a JAVA script for identifying said interface port.

11. The telecommunications system according to claim 5, and further including a security management system for preventing unapproved application software from being downloaded to said interface device.

12. The telecommunications system according to claim 11, wherein said security management system further prevents execution of said application software for an unapproved application end-device.

13. The telecommunications system according to claim 12, wherein said security management system includes a secret request code embedded in said application software, and wherein said interface device includes a public key for encrypting said secret request code prior to sending a communication request to said application end-device.

14. The telecommunication system according to claim 13, wherein said application end-device includes a private key for decrypting said encrypted secret code to be identified as an approved application end-device.

15. The telecommunications system according to claim 12, wherein said security management system utilizes Public Key Encryption Technology.

16. The telecommunications system according to claim 12, wherein a source of said application software, said interface device and said application end-device are approved by a Certification Authority.

17. The telecommunications system according to claim 16, wherein said Certification Authority comprises an operator of said external communications nwtwork.

18. A telecommunications system, comprising:
a local wireless network and a mobile communications network, said local wireless network comprising a plurality of electronic devices including a mobile phone and an application end-device, said mobile phone including an interface for interfacing with said mobile communications network for downloading an application software from an application software source to said mobile phone via said mobile telephone network, said application software establishing a functional relationship between said mobile phone and said application end-device.

19. The system according to claim 18, wherein said interface comprises a JAVA Application Programming Interface.

20. The telecommunications system according to claim 19, wherein said JAVA Application Programming Interface comprises an Application Programming Interface for selectively identifying an interface port for enabling the application software toward the application end-device.

21. The telecommunications system according to claim 20, and further including a JAVA script for identifying said interface port.

22. The telecommunications system according to claim 18, and further including a security management system for preventing unapproved application software from being downloaded to said mobile phone.

23. The telecommunications system according to claim 22, wherein said security management system further prevents execution of said application software for an unapproved application end-device.

24. The telecommunication system according to claim 23, wherein said security management systems includes a secret request code embedded in said application software, and wherein said interface device includes a public key for encrypting said secret request code prior to sending a communication request to said application end-device.

25. The telecommunication system according to claim 24, wherein said application end-device includes a private key for decrypting said encrypted secret request code to be identified as an approved application end-device.

26. The telecommunications system according to claim 23, wherein said security management system utilizes Public Key Encryption Technology.

27. The telecommunications system according to claim 18, wherein said local wireless network comprises a Bluetooth wireless network.

28. A mobile telephone for a local wireless network, said mobile telephone including an interface for interfacing with an external communications network for downloading an application software from an application software source to said mobile telephone via said external communications network.

29. The mobile telephone according to claim 28, wherein said external communications network comprises a mobile communications network.

30. The mobile telephone according to claim 28, wherein said local wireless network comprises a Bluetooth wireless network.

31. The mobile telephone according to claim 28, wherein said local wireless network further includes an application end-device, and wherein said application software establishes a functional relationship between said mobile telephone and said application end-device.

32. The mobile telephone according to claim 31, and further including a key for encrypting a secret request code embedded in said application software prior to sending said secret request code to said application end-device.

33. The mobile telephone according to claim 31, wherein said interface comprises a JAVA Application Programming Interface.

34. The mobile telephone according to claim 33, wherein said JAVA Application Programming Interface comprises an Application Programming Interface for selectively identifying an interface port for enabling the application software toward the application end-device.

35. The mobile telephone according to claim 34, and further including a JAVA script for identifying said interface port.

36. In a telecommunications system that includes a local communications network and an external communications network, the local communications network including an interface device for interfacing with said external communications network, a method for loading application software in said interface device comprising downloading said application software from an application software source to said interface device via said external communications network.

37. The method according to claim 36, wherein said local communications network comprises a local wireless network, said interface device comprises a mobile phone, and said external communications network comprises a mobile communications network.

38. The method according to claim 37, and further including the step of certifying said mobile phone by a Certification Authority to receive said application software before the step of downloading.

39. The method according to claim 38, wherein said Certification Authority comprises an operator of said mobile communications network.

40. The method according to claim 36, and further including the step of charging a fee for downloading said application software.

41. The method according to claim 40, wherein said step of charging a fee comprises an operator of said mobile communications network charging said fee to a service provider that provides said application software.

42. The method according to claim 41, wherein said service provider further charges a fee to an entity that provides said application software.

43. The method according to claim 36, wherein said local wireless network comprises a Bluetooth wireless network.

44. The method according to claim 36, wherein said application software includes a secret request code to be encrypted by said interface device prior to sending said secret request code to an application end-device.
